(19) United States
(12) Patent Application Publication
(10) Pub. No.: US 2021/0237212 A1
(43) Pub. Date: Aug. 5, 2021

(54) SYSTEM AND METHOD FOR WELDING WORKPIECES OF A MOTOR VEHICLE

(71) Applicant: GM Global Technology Operations LLC, Detroit, MI (US)

(72) Inventors: Miguel A Saez, Clarkston, MI (US); Debejyo Chakraborty, Novi, MI (US); Richard J. Skurkis, Lake Orion, MI (US); John P. Spicer, Plymouth, MI (US); Wayne Cai, Troy, MI (US)

(21) Appl. No.: 16/778,861

(22) Filed: Jan. 31, 2020

(51) Int. Cl. B23K 37/04; B23K 31/00; B23K 37/00

(52) U.S. Cl. CPC B23K 37/0443; B23K 31/003; B23K 2101/006; B23K 37/00; B23K 37/003

(57) ABSTRACT

A welding block for a welding system secures together first and second components of a workpiece for a motor vehicle to reduce distortion of the first and second components during a welding process. The welding block includes a jig mechanism that has a proximal surface for receiving a load from an arm of the welding system. The jig mechanism further includes a distal surface for engaging the first component and securing the first and second components to one another during the welding process. The jig mechanism defines a passage, such that heat flows from the distal surface to a coolant flowing through the passage. The welding block further includes a sensor coupled to the jig mechanism for detecting a measured variable associated with at least one of the first and second components.

### INTRODUCTION

The present disclosure relates to systems for welding workpieces of motor vehicles, and more particularly to a system having a welding fixture for reducing distortion of the workpiece, decreasing the associated internal stresses, decreasing gaps between fused components, and monitoring the status and quality of the welding process.

Automotive sheet metal and structural welding is a fabrication process that joins components by using heat to melt the material of components and allowing them to cool and fuse together. Distortion results from the expansion and contraction of the weld metal and adjacent base metal during the heating and cooling cycle of the welding process. During this heating and cooling cycle, many factors affect shrinkage of the metal and lead to distortion, such as physical and mechanical properties that change as heat is applied. For example, as the temperature of the weld area increases, yield strength, elasticity, and thermal conductivity of the steel plate decrease, while thermal expansion and specific heat increase. These changes, in turn, affect heat flow and uniformity of heat distribution. In a welded joint, these same expansion and contraction forces act on the weld metal and on the base metal. As the weld metal solidifies and fuses with the base metal, it is in its maximum expanded from. When the weld metal cools, it attempts to contract to the volume it would normally occupy at room temperature, but it is restrained from doing so by the adjacent base metal. As a result, stresses develop within the weld and the adjacent base metal. At this point, the weld can yield and thin out, thus adjusting to the volume requirements of the lower temperature. But only those stresses that exceed the yield strength of the weld metal are relieved by this straining. When the weld cools to room temperature, the weld contains tensile stresses approximately equal to the yield strength of the metal. If clamps or fixtures that hold the workpiece during welding are removed, the residual stresses are partially relieved as they cause the base metal to move, thus distorting the weldment.

Thus, while existing welding systems and methods achieve their intended purpose, there is a need for a new and improved welding system that addresses these issues.

### SUMMARY

According to several aspects of the present disclosure, a welding block for a welding system secures together first and second components of a workpiece for a motor vehicle to reduce distortion of the first and second components during a welding process. The welding block includes a jig mechanism that has a proximal surface for receiving a load from an arm of the welding system. The jig mechanism further includes a distal surface for engaging the first component and securing the first and second components to one another during the welding process. The jig mechanism defines an inlet, a passage having one end fluidly connected to the inlet, and an outlet fluidly connected to the other end of the passage, such that heat flows from the distal surface to a coolant flowing through the passage. The welding block further includes a sensor coupled to the jig mechanism for detecting a measured variable associated with at least one of the first and second components.

In one aspect, the jig mechanism is a three-dimensionally printed single-piece block that defines the passage.

In another aspect, the passage is arranged in a serpentine pattern extending between the inlet and the outlet.

In another aspect, the sensor is at least one of a Gauss meter probe, a magnet, a camera, a thermocouple, a load cell, a linear variable differential transformer, an ohmmeter, and a voltmeter.

In another aspect, the single-piece body defines a bore extending between the distal and proximal surfaces, and the bore has distal and proximal ends adjacent to an associated one of the distal and proximal surfaces. The sensor is disposed within the distal end of the bore, and a wire extends through the bore and is electrically coupled to the sensor.

In another aspect, the single-piece body defines a bore extending between the distal and proximal surfaces, and the bore has distal and proximal ends adjacent to an associated one of the distal and proximal surfaces. The sensor is disposed within the proximal end of the bore, and a wire is electrically coupled to the sensor and is spaced from the bore.

According to several aspects of the present disclosure, a welding system secures together first and second components of a workpiece for a motor vehicle, and the welding system reduces distortion of the first and second components during a welding process. The welding system includes a clamp mechanism movable between open and closed positions, and the clamp mechanism includes first and second ends for securing the first and second components against one another in response to the clamp mechanism being disposed in the closed position. The welding system further includes a motor for moving the clamp mechanism to the closed position. The welding system further includes first and second welding blocks for transmitting a clamping force from an associated one of the first and second ends of the clamp mechanism to the first and second components. Each of the first and second welding blocks includes a jig mechanism, which has a proximal surface for receiving a load from the welding system and a distal surface for engaging the first component and securing the first and second components to one another during the welding process. The jig mechanism defines an inlet, a passage having one end fluidly connected to the inlet, and an outlet fluidly connected to the other end of the passage, such that heat flows from the distal surface to a coolant flowing through the passage. Each of the first and second welding blocks further includes a sensor coupled to the jig mechanism for detecting a measured variable associated with at least one of the first and second components. The passages of the welding blocks are fluidly connected to one another. The welding system further includes a coolant source fluidly connected to the inlet of at least one of the welding blocks and a pump fluidly connected to the coolant source for pumping the coolant through the passages. The welding system further includes a welding device for welding the first and second components to one another at an interface adjacent to the jig mechanism. The welding system further includes a controller electrically coupled to the sensor, the pump, and the welding device. In response to determining the measured variable, the controller actuates the motor to move the clamp mechanism toward the closed position, actuates the pump to pump the coolant through the passages, and actuates the welding device for welding the first and second components to one another.

In one aspect, the passages of the welding blocks are fluidly connected to one another to form a closed series circuit.

In another aspect, the passages of the welding blocks are fluidly connected to one another to form a closed parallel circuit.

In another aspect, each of the welding blocks defines a single passage.

In another aspect, each of the welding blocks defines a plurality of passages.

According to several aspects of the present disclosure, a method of operating a welding system having first and second welding blocks for securing first and second components of a workpiece during a welding process is provided. Each of the first and second welding blocks includes a jig mechanism having proximal and distal surfaces and a plurality of sensors coupled to the jig mechanism. The method includes the step of detecting, using the sensors, a plurality of measured variables associated with at least one of the first and second components. In response to one or more measured variables, the controller actuates the motor to move the clamp mechanism to a closed position to apply a load to the first and second components. In addition, the controller actuates a pump to pump a coolant through a plurality of passages defined by the jig mechanism. The controller further actuates a welding device to weld the first and second components to one another at a location adjacent to the jig mechanism, and heat is transferred from the distal surface of the jig mechanisms to the coolant flowing through the passages.

In one aspect, the method further includes using a Gauss meter probe and magnet for detecting first and second changes in electromagnetic flux through at least one of the first and second components.

In another aspect, the method further includes the controller determining that the welding block contacted one of the first and second components in response to the Gauss meter probe detecting the first change in electromagnetic flux.

In another aspect, the method further includes the controller determining that the clamp mechanism is disposed in the closed position to close a gap between the first and second components at a location along a longitudinal axis of the workpiece, in response to the Gauss meter probe detecting the second change in electromagnetic flux.

In another aspect, the method further includes welding the first and second components to one another in response to detecting the second change in electromagnetic flux.

In another aspect, the method includes a camera detecting a plurality of gaps between the first and second components at a plurality of locations along a longitudinal axis of the first and second components. The method further includes determining a largest one of the gaps at an associated location along the longitudinal axis, positioning at least one of the jig mechanisms at the associated location along the longitudinal axis, and distributing the load from the distal surface of the jig mechanism to the first component at the associated location along the longitudinal axis.

In another aspect, the method includes a thermocouple detecting a measured temperature of at least one of the first and second components. The method further includes the controller comparing the measured temperature to a threshold temperature, with the controller actuating the pump to pump the coolant through the passages in response to the controller determining that the measured temperature is higher than the threshold temperature.

In another aspect, the method includes a load cell measuring a load that the associated jig mechanism is applying to the workpiece. The method further includes the controller comparing the measured load to a threshold load, with the controller deactivating the motor of the clamping mechanism in response to the controller determining that the measured load is higher than a threshold load.

In another aspect, the method includes a linear variable displacement transformer for measuring the linear displacement of the jig mechanism. The controller determines a displacement rate of the jig mechanism in response to the measured linear displacement and an elapsed time. The controller further determines a change in displacement rate when the gap is closed and both the first and second components receive the load. The controller deactivates the motor in response to the controller determining that there has been a change in displacement rate.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

FIG. 1 is a schematic diagram of a system having a plurality of welding fixtures and clamp mechanisms for joining first and second components of a workpiece for a motor vehicle, illustrating the welding blocks fluidly connected to one another in a closed parallel circuit.

FIG. 2 is a cross-sectional schematic view of the system of FIG. 1 as taken along line 2-2, illustrating the workpiece having first and second components secured to one another by one of the clamp mechanisms and two associated welding fixtures.

FIG. 3 is a cross-sectional view of the welding block of FIG. 2, as taken along line 3-3, illustrating the welding block having a jig mechanism that has a plurality of sensors and defines a serpentine passage for coolant.

FIG. 4 is a cross-sectional view of the system of FIG. 1, as taken along line 4-4, illustrating a first sensor disposed on a distal side of the jig mechanism and a second sensor disposed on a proximal side of the jig mechanism.

FIG. 5 is a cross-sectional view of another example of the welding block of FIG. 2, illustrating the jig mechanism defining two serpentine passages disposed parallel to one another.

FIG. 6 is a schematic diagram of another example of the system of FIG. 1, illustrating the welding blocks fluidly connected to one another in a closed series circuit.

FIG. 7 is a cross-sectional view of another example of a welding block, illustrating the welding block having a jig mechanism that defines a serpentine passage formed on a distal surface contacting the workpiece.

FIG. 8 is a flow chart for an example of a method for operating the system of FIG. 1.

### DETAILED DESCRIPTION

The following description is merely exemplary in nature and is not intended to limit the present disclosure, application, or uses.

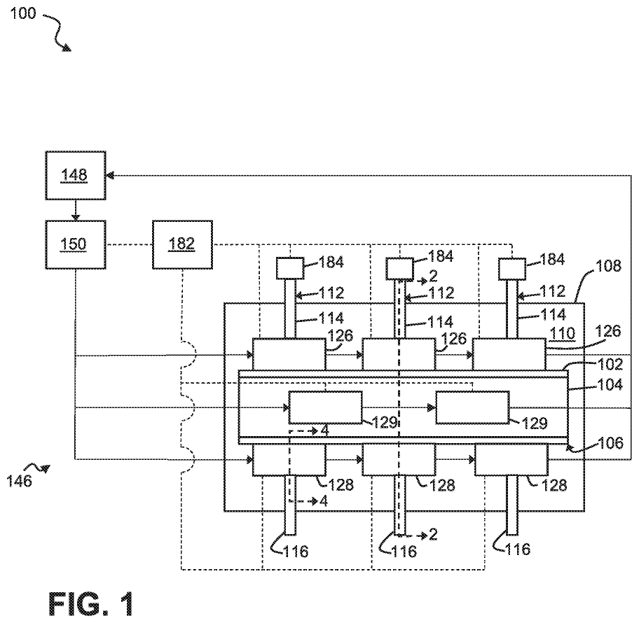

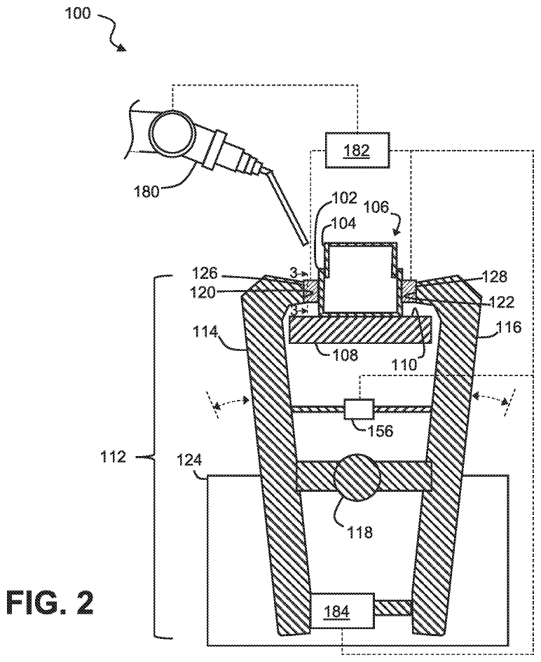

Referring to FIGS. 1 and 2, one example of a system 100 is configured to secure first and second components 102, 104 of a workpiece 106 for a motor vehicle during a welding process and the system 100 is configured to reduce distortion of the first and second components 102, 104. In this example, the system 100 includes a table 108 having a top surface 110 for supporting the first and second components 102, 104. The system 100 further has a plurality of clamp mechanisms 112 spaced from one another along a longitudinal axis of the table 108. Each clamp mechanism 112 is movable between open and closed positions.

As best shown in FIG. 2, each clamp mechanism 112 includes first and second arms 114, 116 angularly displaceable relative to one another about a pivoting coupler 118. The first and second arms 114, 116 have associated first and second ends 120, 122 for securing the first and second components 102, 104 against one another and hold the components in a fixed position, in response to the clamp mechanism 112 being disposed in the closed position. In this example, each clamp mechanism 112 includes a stationary base 124 that supports the pivoting coupler 118 and is positioned on the floor. However, other examples of the clamp mechanism may have a base mounted to the end of an articulating robotic arm.

Each clamp mechanism 112 includes a motor 184 for moving the clamp mechanism 112 from the open position to the closed position for displacing the first and second ends 120, 122 of the first and second arms 114, 116 toward one another and securing the first and second components 102, 104 in a fixed position against one another.

The system 100 includes first and second welding blocks 126, 128 for transmitting a clamping force from an associated one of the first and second ends 120, 122 of the clamp mechanism 112 to the first and second components 102, 104. In addition, as described in detail below, the welding blocks 126, 128 are configured to detect one or more measured variables associated with the first and second components and remove heat from those components to prevent weld distortion. Also, in this example, the system 100 further includes one or more welding blocks 129 that are identical to the welding blocks 126, 128. However, while the welding blocks 126, 128 are used for transmitting a clamping force, detecting measure variables, and cooling the workpiece 106, the welding blocks 129 are not coupled to the clamp mechanism 112 and do not transmit a clamping force to the first and second components 102, 104.

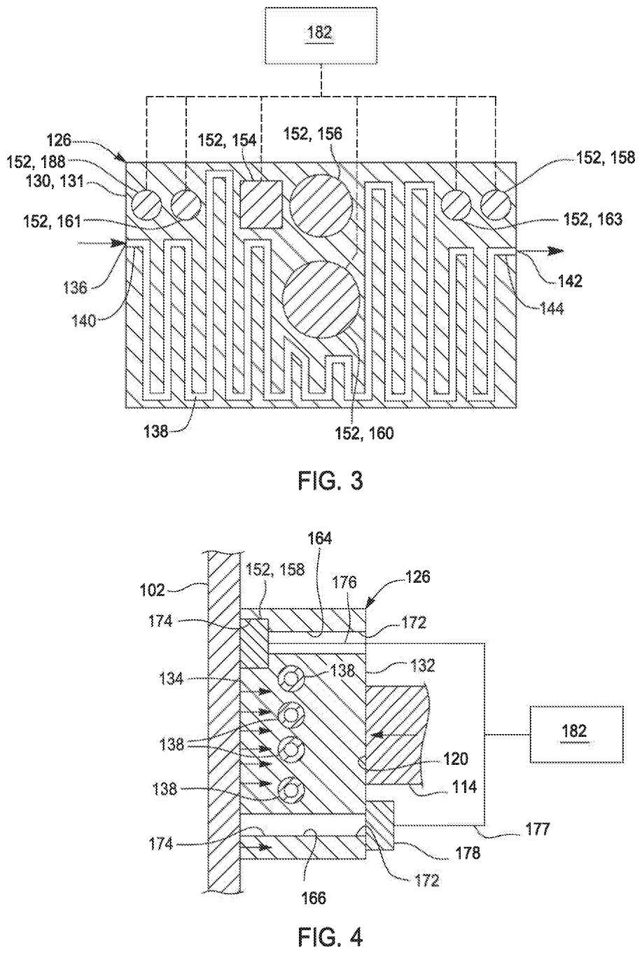

Referring to FIGS. 3 and 4, each of the first and second welding blocks 126, 128 includes a jig mechanism 130 having a proximal surface 132 (FIG. 4) for receiving a load from the welding system 100 and a distal surface 134 (FIG. 4) for applying the clamping force to the first and second components 102, 104. As best shown in FIG. 3, the jig mechanism 130 defines an inlet 136, a single passage 138 having one end 140 fluidly connected to the inlet 136, and an outlet 142 fluidly connected to the other end 144 of the passage 138, such that heat flows from the distal surface 134 to a coolant flowing through the passage 138. In this example, the passage 138 is arranged in a serpentine pattern extending between the inlet 136 and the outlet 142. Furthermore, the jig mechanism 130 is a three-dimensionally printed single-piece block 131 that defines the single passage 138. It is contemplated that the passage can include a liner, and the welding block can have any number of the passages arranged in serpentine, linear, arcuate, or other suitable patterns. In addition, the welding block can be formed from any suitable materials and by other suitable associated fabrication process.

Referring back to FIG. 1, the passages 138 of the welding blocks 126, 128 are fluidly connected to one another to form a closed parallel circuit 146 where the coolant flows along a plurality of paths. The system 100 further includes a coolant source 148 fluidly connected to the inlet 136 of at least one of the welding blocks 126, 128 for supplying the coolant to the welding blocks 126, 128. The system 100 further include a pump 150 fluidly connected to the coolant source 148 for pumping the coolant through the passages 138. In other embodiments, the passages of the blocks can be fluidly connected to one another in other suitable ways and/or be portions of an open circuit.

Referring to FIG. 3, each of the first and second welding blocks 126, 128 further includes one or more sensors 152 for collecting signal data that can be used for determining the status and or quality of the welding process. The sensors 152 are coupled to the jig mechanism 130 for detecting a measured variable associated with at least one of the first and second components 102, 104. In this example, the sensors 152 include a Gauss meter probe 154 and a magnet 156 for detecting first and second changes in electromagnetic flux through at least one of the first and second components 102, 104. However, it is contemplated that the sensors can include a Hall effect sensor or flux meter for measuring a magnetic flux associated with a gap between the parts being joined. As the first and second components are held more tightly together, any of the magnetic sensors may detect that magnetic flux through the first and second components has increased. The sensors 152 further include a thermocouple 158 for detecting a temperature of at least one of the first and second components 102, 104. In addition, the sensors 152 further include a linear variable displacement transformer 188 for detecting displacement of the associated jig mechanism 130. The sensors 152 further include a load cell 160 for detecting a force or load that the associated jig mechanism is applying to the workpiece 106. Still, in other examples, the sensors can include an ohmmeter 161 for measuring electrical resistance and a voltmeter 163 for measuring voltage drop across the contact between the fixture on one side of the first component and the fixture on the opposite side of the second component. As the first and second components are held more tightly together, the ohmmeter 161 and voltmeter 163 may detect that electrical contact resistance has reduced. It is contemplated that the system can include any suitable sensor for controlling operation of the motors of the clamp mechanism, the pump, and the welding device. The above description of the sensors and the control of the motors, the pump, and the welding device merely illustrate non-limiting examples of the same.

Referring to FIG. 4, the jig mechanism 130 is a single-piece body 162 defining one or more bores 164, 166 (FIG. 4) containing sensors or providing a clear path for an associated sensor to detect a measured variable. The bores 164, 166 extend between the distal and proximal surfaces 132, 134, and each bore 164 has proximal and distal ends 172, 174 adjacent to an associated one of the distal and proximal surfaces 132, 134, with one of the sensors 152 being disposed within the distal end 172 of the bore 164 and a wire 176 extending through the bore and electrically coupled to the sensor 152. As but one example, the thermocouple 158 may be disposed within the distal end 174 of the bore 164 to be disposed adjacent to the first component 102 of the workpiece 106 to measure the temperature of the first component 102. Another one of the sensors 153 is disposed adjacent to the proximal end 172 of another bore 166, and a wire 177 is electrically coupled to the sensor 153 and spaced from the bore 166. The sensors 152 of each welding block 126 can further include a camera 178 for detecting a gap between the first and second components 102, 104 at the associated location of the welding block 126 along the longitudinal axis of the first and second components 102, 104.

The system 100 further includes a welding device 180 (FIG. 2) for welding the first and second components 102, 104 to one another at an interface adjacent to the jig mechanism 130. The system 100 further includes a controller 182 electrically coupled to the sensors 152, the pump 150 (FIG. 1), and the welding device 180. In response to determining the measured variable as described below, the controller 182 actuates the motor 184 to move the clamp mechanism 112 toward the closed position, actuates the pump 150 to pump the coolant through the passages 138, and actuates the welding device 180 to weld the first and second components 102, 104 to one another.

More specifically, the controller 182 determines that the welding block 126 contacted one of the first and second components 102, 104 in response to the Gauss meter probe 154 detecting the first change in electromagnetic flux. The controller further determines that the associated clamp mechanism 112 is disposed in the closed position to close a gap between the first and second components 102, 104 at the associated location along the longitudinal axis of the workpiece 106, in response to the Gauss meter probe 154 detecting the second change in electromagnetic flux. In response to determining that the gap is closed, the controller 182 actuates the motor 184 to hold the clamp mechanism 112 in its current position, actuates the pump 150 to circulate coolant through the associated welding block 126, and actuates the welding device 180 to weld the first and second components to one another at the associated location.

By way of another non-limiting example, the controller 182 determines the largest gap between the first and second components 102, 104 and its location along the longitudinal axis 186. The controller 182 actuates the motor of the clamp mechanism 112 closest to this location to move the clamp mechanism 112 to the closed position and distribute the load from the distal surface 134 of the associated welding block 126 to the first component 102.

In another non-limiting example, the controller 182 compares the measured temperature detected by the thermocouple 158 to a threshold temperature. In response to the controller 182 determining that the measured temperature is higher than the threshold temperature, the controller 182 actuates the pump 150 to pump the coolant through the passages 138.

In still another non-limiting example, the controller 182 compares the load measured by the load cell 160 to a threshold load. In response to the controller 182 determining that the measured load is higher than a threshold load when, for example, the gap is closed and both first and second components receive the clamping force, the controller 182 deactivates the motor 184 and decreases the load that the clamp mechanism applies to the first and second components 102, 104.

The controller 182 determines an estimated displacement rate of the jig mechanism, in response to the linear displacement measured by the linear variable differential transformer 188. The controller 182 determines that there has been a change in the displacement rate when the gap closes and both the first and second components 102, 104 oppose the clamping force applied by the clamp mechanism. In response to the controller 182 determining that there has been a change in displacement rate, the controller 182 deactivates the motor 184 to stop the clamp mechanism from moving the ends of the arms closer together.

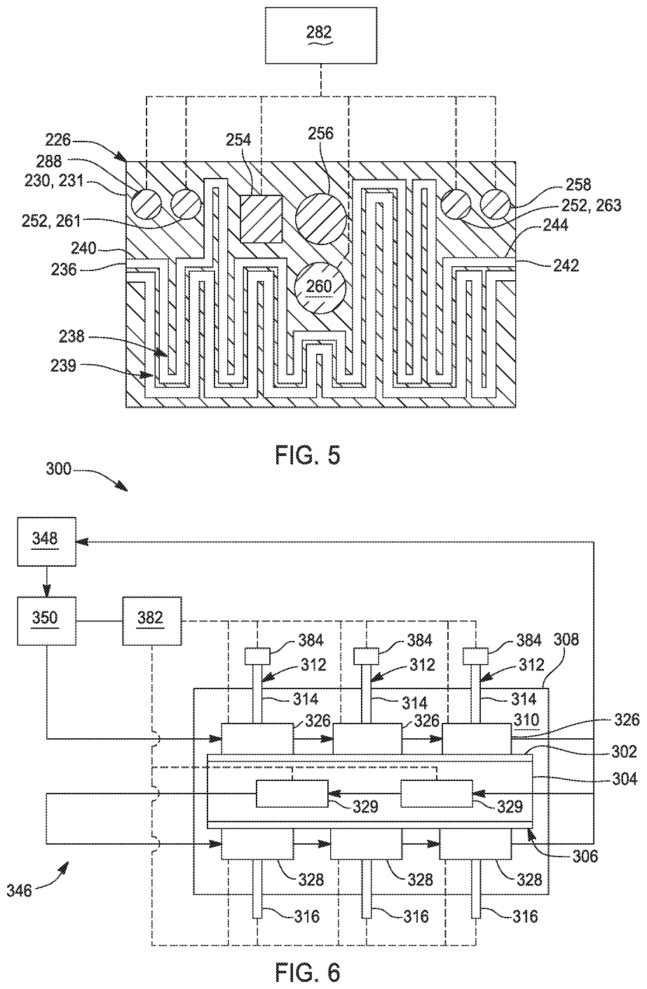

Referring to FIG. 5, a welding block 226 is similar to the welding block 126 of FIG. 3 and includes components identified by the same reference numbers increased by 100. However, while the welding block 126 of FIG. 3 includes a single passage for flowing coolant through the welding block 126, the welding block 226 includes two passages 238, 239 nested to one another in respective serpentine patterns for flowing coolant through the welding block. The controller may actuate one or more pumps and associated valves for flowing coolant through either one of the passages or both of the passages, in response to the measured variables detected by the sensors.

Referring to FIG. 6, a system 300 having a plurality of welding blocks 326 is similar to the system 100 of FIG. 1 and includes components identified by the same reference numbers increased by 200. While the system 100 of FIG. 1 includes welding blocks 126, 128 having passages 138 fluidly connected to one another in a closed parallel circuit 146, the system 300 of FIG. 6 includes welding blocks 326 having passages 338 fluidly connected to one another in a closed series circuit 346.

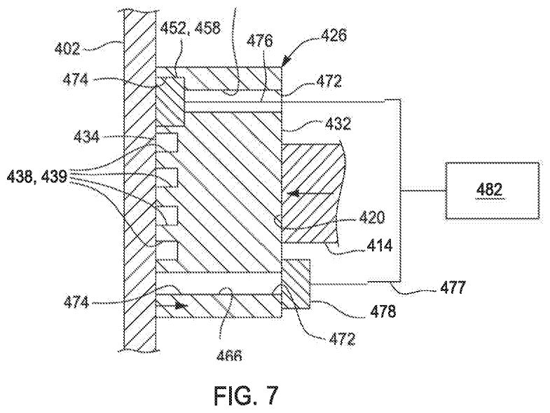

Referring to FIG. 7, another example of a welding block 426 is similar to the welding block 426 of FIG. 3 and has the same components identified by the same numbers increased by 300. However, while the jig mechanism 130 of FIG. 3 defines the passage 138 spaced from the distal surface 134, the jig mechanism 430 of FIG. 7 has a passage 438 that is a serpentine groove or channel 439 formed within the distal surface 434 that engages at least one of the first and second components. In this example, the coolant can be air flowing through the passage 438, such that a portion of the heat can be transferred directly from the workpiece 406 to the air flowing within the passage 438. Heat can also be transferred from the workpiece 406 through the jig mechanism 430 and into the air flowing through the passage 438. Also, in this example, the sensors 452 can include a pressure sensor 165 for detecting a first pressure when the distal surface 434 is in contact with the workpiece 406 and a second pressure when the distal surface 434 is spaced from the workpiece 406, with the second pressure being lower than the first pressure due to air leaking out of the passage 438. In one example, the second pressure can be associated with debris between the welding block 426 and the workpiece, which reduces surface contact between the same and reduces the associated ability to transfer heat from the workpiece to the welding block. Put another way, the difference in pressure can correspond with the amount of surface contact between the welding block 426 and the workpiece 406.

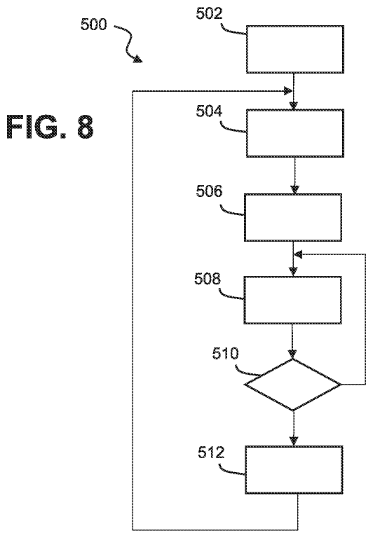

Referring to FIG. 8, a flow chart for one example of a method 500 for operating the system 100 of FIG. 1 is shown. The method commences at block 502 with the controller 182 determining the largest gap between the first and second components 102, 104 along the longitudinal axis. The controller 182 actuates the clamp mechanism 112 to move to the closed position and close the gap at the associated location. The load is distributed from the distal surface of the jig mechanism 130 to the first component 102 at the associated location along the longitudinal axis 186.

At block 504, the sensors 152 detect a plurality of measured variables associated with the first and second components 102, 104. The Gauss meter probe 154 and the magnet 156 may detect first and second changes in electromagnetic flux through at least one of the first and second components 102, 104. In addition, the camera 178 may detect gaps and measure gap widths between the first and second components 102, 104 along the longitudinal axis 186 of the first and second components 102, 104. In addition, the thermocouple 158 may detect the temperature of the first and second components 102, 104. The load cell 160 may detect the load that the associated jig mechanism is applying to the workpiece. The linear variable differential transformer 188 may measure linear displacement of the associated jig mechanism 130.

At block 506, the controller 182 determines the presence of a gap between the first and second components 102, 104 in response to the measured variables detected by the sensors 152. More specifically, the controller 182 determines that the welding block contacted one of the first and second components 102, 104 as the clamp mechanism moves toward the closed position, in response to the Gauss meter probe 154 detecting the first change in electromagnetic flux. In addition, the controller 182 determines that the clamp mechanism 112 has reached the closed position for closing the gap between the first and second components 102, 104 and contacting them with one another, in response to the Gauss meter probe 154 detecting the second change in electromagnetic flux with the electromagnetic flux increasing as the components are held more tightly together. In another example, the controller 182 determines an estimated displacement rate of the jig mechanism 130 based on the measured linear displacement over an elapsed time. The controller 182 determines that there has been a change in displacement rate when the gap is closed and both the first and second components receive the load at the associated location. In yet another example, the controller 182 determines that the load is equal to or higher than a threshold load associated with the gap being closed when both the first and second components are opposing the load applied by the clamp mechanism. In still another example, the controller 182 determines that the electrical resistance has decreased in response to the first and second components contacting one another with the gap closed therebetween.

At block 508, the controller 182 actuates the welding device 180 to weld the first and second components 102, 104 together at the location adjacent to the jig mechanism 130, and the controller 182 deactivates the motor 184 in response to the controller: (1) detecting the second change in electromagnetic flux; (2) determining that the measured load is higher than a threshold load; (3) determining that there has been a change in displacement rate of the jig mechanism; and (4) determining that there has been a change in electrical resistance. It is contemplated that any one of these conditions or other conditions can initiate this step.

At block 510, the controller 182 compares the measured temperature to a threshold temperature. If the controller 182 determines that the temperature is higher than the threshold temperature, the method proceeds to block 508. If the controller 182 determines that the temperature is below the threshold temperature, the method returns to block 504.

At block 512, the controller 182 actuates the pump 150 to pump the coolant through the passages 138, and heat transfers from the distal surface 134 of the jig mechanism 130 to the coolant flowing through the passages 138. The method returns to block 504.

The description of the present disclosure is merely exemplary in nature and variations that do not depart from the general sense of the present disclosure are intended to be within the scope of the present disclosure. Such variations are not to be regarded as a departure from the spirit and scope of the present disclosure.

What is claimed is:

1. A welding block for a welding system that secures together first and second components of a workpiece for a motor vehicle to reduce distortion of the first and second components during a welding process, the welding block comprising:
a jig mechanism having a proximal surface receiving a load from an arm of the welding system and a distal surface for engaging the first component and securing the first and second components to one another during the welding process, where the jig mechanism defines an inlet, a passage having one end fluidly connected to the inlet, and an outlet fluidly connected to the other end of the passage, such that heat flows from the distal surface to a coolant flowing through the passage; and
a sensor coupled to the jig mechanism for detecting a measured variable associated with at least one of the first and second components.

2. The welding block of claim 1 wherein the jig mechanism comprises a three-dimensionally printed single-piece block that defines the passage.

3. The welding block of claim 2 wherein the passage is arranged in a serpentine pattern extending between the inlet and the outlet.

4. The welding block of claim 3 wherein the sensor is at least one of a Gauss meter probe, a magnet, a camera, a thermocouple, a load cell, a linear variable differential transformer, an ohmmeter, and a voltmeter.

5. The welding block of claim 3 wherein the single-piece body defines a bore extending between the distal and proximal surfaces, and the bore has distal and proximal ends adjacent to an associated one of the distal and proximal surfaces, with the sensor being disposed within the distal end of the bore and a wire extending through the bore and electrically coupled to the sensor.

6. The welding block of claim 3 wherein the single-piece body defines a bore extending between the distal and proximal surfaces, and the bore has distal and proximal ends adjacent to an associated one of the distal and proximal surfaces, with the sensor being disposed within the proximal end of the bore and a wire electrically coupled to the sensor and spaced from the bore.

7. A welding system that secures together first and second components of a workpiece for a motor vehicle and reduces distortion of the first and second components during a welding process, the welding system comprising:
a clamp mechanism movable between open and closed positions, and the clamp mechanism includes first and second ends for securing the first and second components against one another in response to the clamp mechanism being disposed in the closed position;
a motor for moving the clamp mechanism to the closed position;
first and second welding blocks for transmitting a clamping force from an associated one of the first and second ends of the clamp mechanism to the first and second components, with each of the first and second welding blocks comprising:
a jig mechanism having a proximal surface for receiving a load from the welding system and a distal surface for engaging the first component and securing the first and second components to one another during the welding process, where the jig mechanism defines an inlet, a passage having one end fluidly connected to the inlet, and an outlet fluidly connected to the other end of the passage, such that heat flows from the distal surface to a coolant flowing through the passage; and
a sensor coupled to the jig mechanism for detecting a measured variable associated with at least one of the first and second components;
wherein the passages of the welding blocks are fluidly connected to one another;
a coolant source fluidly connected to the inlet of at least one of the welding blocks for supplying the coolant to the welding blocks;
a pump fluidly connected to the coolant source for pumping the coolant through the passages;
a welding device for welding the first and second components to one another at an interface adjacent to the jig mechanism; and
a controller electrically coupled to the sensor, the pump, and the welding device;
in response to determining the measured variable, the controller:
actuates the motor to move the clamp mechanism toward the closed position;
actuates the pump to pump the coolant through the passages; and
actuates the welding device for welding the first and second components to one another.

8. The welding system of claim 7 wherein the passages of the welding blocks are fluidly connected to one another to form a series circuit where the coolant flows along one path in a closed circuit.

9. The welding system of claim 7 wherein the passages of the welding blocks are fluidly connected to one another to form a parallel circuit where the coolant flows along a plurality of paths in a closed circuit.

10. The welding system of claim 7 wherein each of the welding blocks defines a single passage.

11. The welding system of claim 7 wherein each of the welding blocks defines a plurality of passages.

12. A method of operating of a welding system having first and second welding blocks for securing together first and second components of a workpiece during a welding process, where each of the first and second welding blocks includes a jig mechanism having proximal and distal surfaces and a plurality of sensors coupled to the jig mechanism, the method comprising:
detecting, using the sensors, a plurality of measured variables associated with at least one of the first and second components; and
in response to at least one of the measured variables:
actuating, using the controller, a pump to pump a coolant through a plurality of passages defined by the jig mechanisms;
actuating, using the controller, a welding device to weld the first and second components to one another at a location adjacent to the jig mechanism; and
transferring heat from the distal surface of the jig mechanisms to the coolant flowing through the passages.

13. The method of claim 12 wherein detecting the plurality of measured variables comprises detecting, using a Gauss meter probe and a magnet, first and second changes in electromagnetic flux through at least one of the first and second components.

14. The method of claim 13 further comprising determining, using the controller, that the welding block contacted one of the first and second components in response to the Gauss meter probe detecting the first change in electromagnetic flux.

15. The method of claim 14 further comprising determining, using the controller, that the clamp mechanism is disposed in the closed position to close a gap between the first and second components at a location along a longitudinal axis of the workpiece, in response to the Gauss meter probe detecting the second change in electromagnetic flux.

16. The method of claim 15 further comprising welding the first and second components to one another in response to detecting the second change in electromagnetic flux.

17. The method of claim 12 wherein detecting the plurality of measured variables comprises:
detecting, using a camera, a plurality of gaps between the first and second components at a plurality of locations along a longitudinal axis of the first and second components;
determining, using a controller, a largest one of the gaps at an associated location along the longitudinal axis;
positioning at least one of the jig mechanisms at the associated location along the longitudinal axis; and
distributing the load from the distal surface of the jig mechanism to the first component at the associated location along the longitudinal axis.

18. The method of claim 12 wherein detecting the plurality of measured variables comprises:
detecting, using a thermocouple, a measured temperature of at least one of the first and second components;
comparing, using the controller, the measured temperature to a threshold temperature; and
actuating, using the controller, the pump to pump the coolant through the passages in response to the controller determining that the measured temperature is higher than the threshold temperature.

19. The method of claim 12 wherein detecting the plurality of measured variables comprises:
detecting, using a load cell, a measured load that the associated jig mechanism is applying to the workpiece;
comparing, using the controller, the measured load to a threshold load; and
deactivating, using the controller, the motor in response to the controller determining that the measured load is higher than a threshold load.

20. The method of claim 12 wherein detecting the plurality of measured variables comprises:
detecting, using a linear variable differential transformer, a measured linear displacement of the associated jig mechanism;
determining, using the controller, an estimated displacement rate of the jig mechanism in response to the measured linear displacement;
determining, using the controller, that there is a change in displacement rate of the jig mechanism; and
deactivating, using the controller, the motor in response to the controller determining that there has been a change in displacement rate of the jig mechanism.
